(19) United States
(12) Patent Application Publication
(10) Pub. No.: US 2025/0334003 A1
(43) Pub. Date: Oct. 30, 2025

(54) VIEW CHANGER

(71) Applicant: Kun Baek SONG, Sejong-si (KR)

(72) Inventor: Kun Baek SONG, Sejong-si (KR)

(21) Appl. No.: 19/262,109

(22) Filed: Jul. 8, 2025

Related U.S. Application Data
(63) Continuation of application No. PCT/KR2024/001249, filed on Jan. 26, 2024.

(30) Foreign Application Priority Data
Feb. 15, 2023 (KR) 10-2023-0019969

(51) Int. Cl. E06B 9/386; E06B 9/24; E06B 9/36

(52) U.S. Cl. CPC E06B 9/386; E06B 9/368; E06B 2009/2417; E06B 2009/2452

(57) ABSTRACT

The view changer includes a frame detachably fitted into a window so as to be optionally reversible in a left-and-right direction, a plurality of indoor reflectors vertically aligned in parallel between a top frame and a bottom frame of the frame, and a plurality of outdoor reflectors arranged at rear sides of the respective indoor reflectors and primarily reflecting incident light from an external view to adjacent indoor reflectors, wherein the outdoor reflectors are configured so that a reflection angle for reflecting the light from the external view is adjustable relative to an angle of the indoor reflectors, and the indoor reflectors blocks a forward view and secondarily reflects the light from the external view already reflected by the outdoor reflectors, thereby allowing the light from the external view to enter an interior space so that the external image is seen in the form of vertically parallel-segmented views.

### TECHNICAL FIELD

The present disclosure relates generally to a view changer. More particularly, the present disclosure relates to a view changer which not only performs the basic function of a conventional blind, but also protects privacy by blocking a forward view from facing buildings, while allowing an external view from directions without buildings to be seen from the interior space in such a manner that it is divided into segmented views that are vertically parallel without left-right reversal.

### BACKGROUND ART

In general, a blind is a device installed in front of a window to block sunlight. It consists of multiple narrow and long thin strips (hereinafter referred to as “slats”) connected by multiple cords. By adjusting the movement of the cords, the opening angle of the slats can be controlled, allowing a user to block sunlight as needed, and to collectively raise and fold the slats upward.

However, conventional known blinds configured as described above are problematic in that it is difficult to secure a view from the inside to the outside when the blind is angled to block direct sunlight.

Another problem is that while opening the slats provides a view, it can also compromise privacy when facing other buildings.

Therefore, there is a demand for a device with a structure that can block a forward view from facing buildings while still allowing an external view to be seen from indoors.

### DISCLOSURE

### Technical Problem

Accordingly, the present disclosure has been made keeping in mind the above problems occurring in the related art, and a first objective of the present disclosure is to provide a view changer that not only performs the basic function of a conventional blind, but also protects privacy by blocking a forward view from facing buildings, while allowing a lateral external view from directions without buildings to be seen from the interior space.

A second objective of the present disclosure is to provide a view changer that doubly reflects light from an external view so that the external view is seen in the form of vertically parallel-segmented views without left-right reversal.

### Technical Solution

In order to accomplish the above objectives, according to a first disclosure, there is provided a view changer, including: a frame detachably fitted into a window so as to be optionally reversible in a left-and-right direction; a plurality of indoor reflectors vertically aligned in parallel between a top frame and a bottom frame of the frame; and a plurality of outdoor reflectors arranged at rear sides of the respective indoor reflectors and configured to primarily reflect incident light from an external view to adjacent indoor reflectors, wherein the outdoor reflectors may be configured so that a reflection angle for reflecting the light from the external view is adjustable relative to an angle of the indoor reflectors, and the indoor reflectors may block a forward view and secondarily reflect the light from the external view already reflected by the outdoor reflectors, thereby allowing the light from the external view to enter an interior space so that the external view is seen in the form of vertically parallel-segmented views without left-right reversal.

According to a second disclosure, in the first disclosure, each of the indoor reflectors may be installed at an inclination of 45° relative to an interior direction of a building, and an interval between the indoor reflectors may be set so that a width-wise indoor-side edge of each of the indoor reflectors is aligned on a vertical line with an outdoor-side edge of an adjacent indoor reflector, thereby blocking the forward view.

According to a third disclosure, in the first disclosure, each of the outdoor reflectors may further include a first rotation axis coupled to the top frame so as to adjust the reflection angle, and each of the indoor reflectors may include a second rotation axis coaxially connected to a lower end of the first rotation axis via a bearing and coupled to the bottom frame.

According to a fourth disclosure, in the first disclosure, a pleated sheet may be is coupled between each of the indoor reflectors and each of the outdoor reflectors.

According to a fifth disclosure, in the third disclosure, a first driven pulley may be externally mounted on an upper end of the first rotation shaft, and a first adjustment lever may be coupled to the top frame of the frame so as to be exposed to the interior space, the first adjustment lever including a worm gear provided with a first drive pulley configured to rotate the first driven pulley via a belt.

According to a sixth disclosure, in the third disclosure, a second driven pulley may be externally mounted on a lower end of the second rotation shaft, and a second adjustment lever may be coupled to the bottom frame of the frame so as to be exposed to the interior space, the second adjustment lever including a worm gear provided with a second drive pulley configured to rotate the second driven pulley via a belt.

### Advantageous Effects

According to a view changer of the present disclosure, it can not only perform the basic function of a conventional blind, but also can protect privacy by blocking a forward view from facing buildings, while allowing a lateral external view from directions without buildings to be seen from the interior space.

Additionally, the view changer can doubly reflect light from the external view to enable the external view to be seen in the form of vertically parallel-segmented views without left-right reversal, thereby enhancing an aesthetic effect.

Furthermore, since the view changer also serves the function of a blind, it can be easily used as a replacement for conventional blinds.

### DESCRIPTION OF DRAWINGS

FIG. 1 is a perspective view illustrating a view changer according to the present disclosure.

FIG. 2 is a perspective view illustrating the view changer according to the present disclosure installed in a left-right reversed configuration.

FIG. 3 is a perspective view illustrating the view changer with a frame removed from FIG. 1.

FIG. 4 is a configuration view illustrating the arrangement interval of an indoor frame in FIG. 3.

FIG. 5 illustrates a perspective view and an exploded perspective view of an indoor reflector and an outdoor reflector extracted from FIG. 1.

FIG. 6 is a conceptual view illustrating the usage state of the view changer according to the present disclosure.

FIG. 7 is an operation view illustrating the angle adjustment of the outdoor reflector and the indoor reflector of the view changer according to the present disclosure.

### BEST MODE

The above and other objectives, features, and advantages of the present disclosure will be readily understood through the following preferred exemplary embodiments in conjunction with the accompanying drawings. The present disclosure may, however, be embodied in many different forms and should not be construed as limited to the exemplary embodiments set forth herein.

Rather, these exemplary embodiments are provided so that this disclosure will be thorough and complete, and will fully convey the scope of exemplary embodiments to those of ordinary skill in the art.

The exemplary embodiments described and illustrated herein also include complementary exemplary embodiments thereof.

As used herein, the singular forms are intended to include the plural forms as well, unless the context clearly indicates otherwise. It will be further understood that the terms “comprises” and/or “comprising”, when used herein, specify the presence of stated elements, but do not preclude the presence or addition of other elements, unless otherwise defined.

Hereinafter, the present disclosure will be described in detail with reference to the drawings. In describing the specific exemplary embodiments below, various characteristic contents have been prepared to more specifically explain the disclosure and help understanding. However, a reader having enough knowledge in this field to understand the present disclosure may recognize that the present disclosure may be used without these various specific details. In some cases, it is mentioned in advance that in describing the present disclosure, parts that are commonly known and not largely related to the present disclosure are not described in order to avoid confusion in explaining the present disclosure.

A view changer according to the present disclosure will now be described in detail with reference to the accompanying drawings. Hereinafter, a view changer according to the present disclosure will be described in detail with reference to the accompanying drawings.

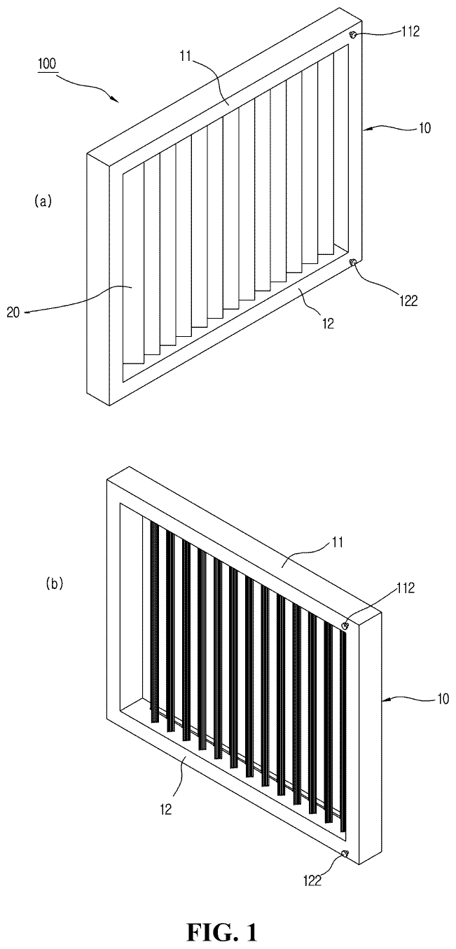

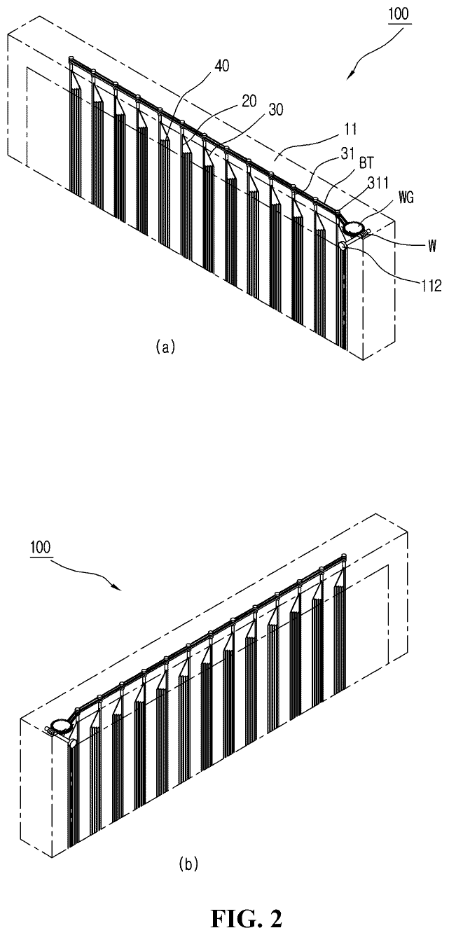

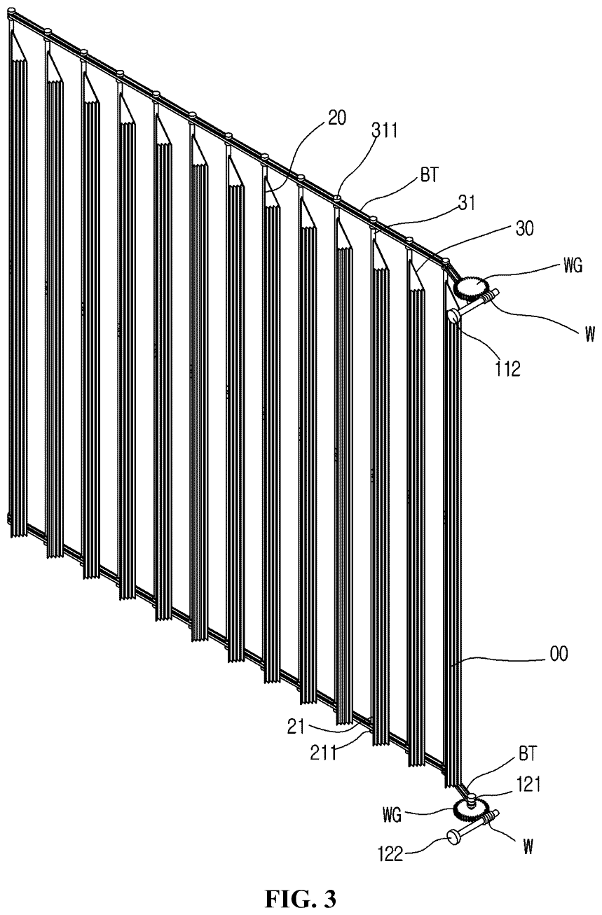

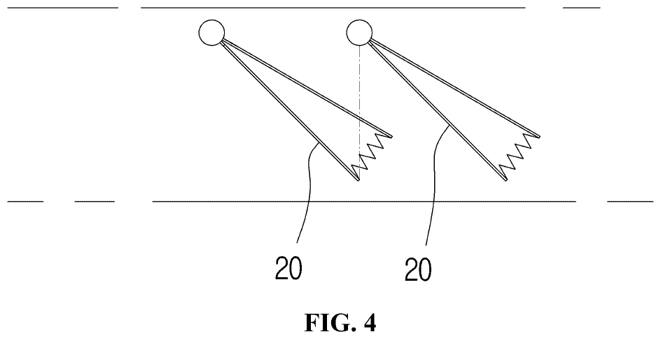

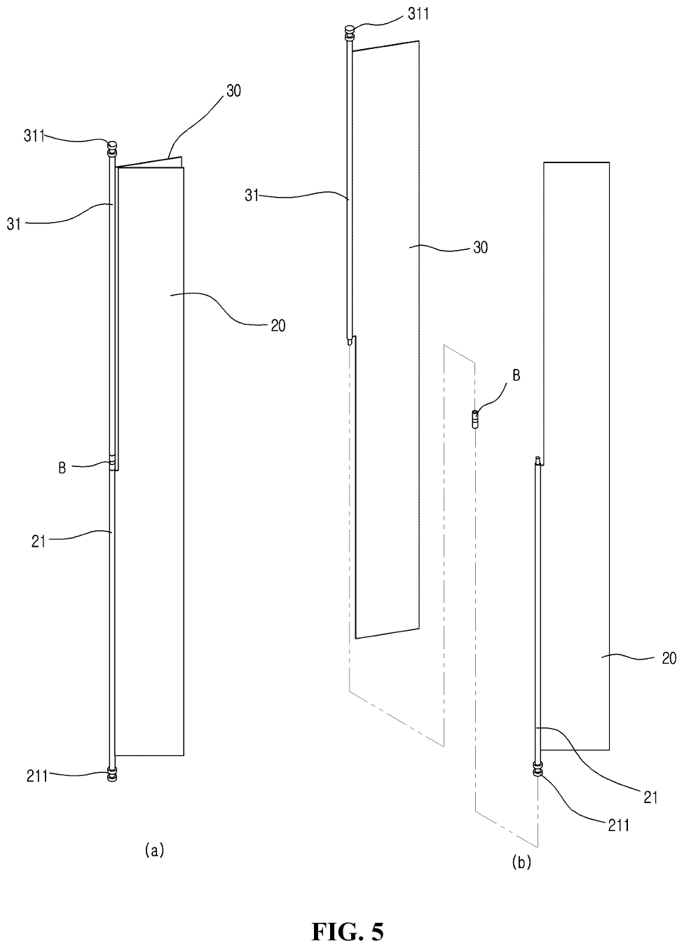

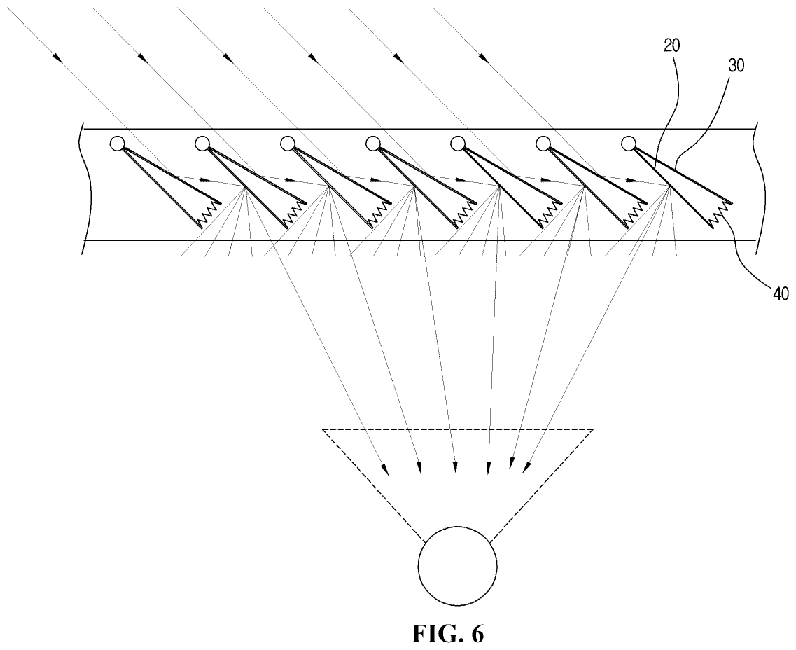

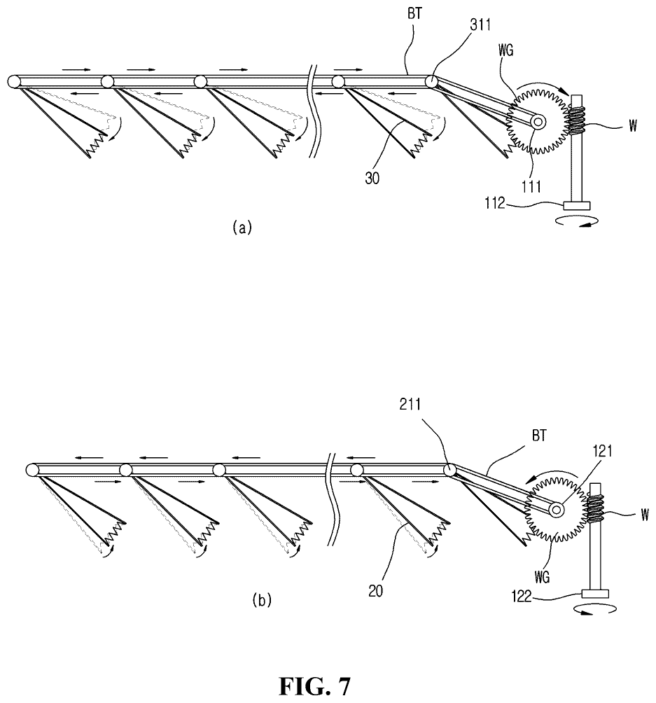

FIG. 1 is a perspective view illustrating a view changer according to the present disclosure. FIG. 2 is a perspective view illustrating the view changer according to the present disclosure installed in a left-right reversed configuration. FIG. 3 is a perspective view illustrating the view changer with a frame removed from FIG. 1. FIG. 4 is a configuration view illustrating the arrangement interval of an indoor frame in FIG. 3. FIG. 5 illustrates a perspective view and an exploded perspective view of an indoor reflector and an outdoor reflector extracted from FIG. 1. FIG. 6 is a conceptual view illustrating the usage state of the view changer according to the present disclosure. FIG. 7 is an operation view illustrating the angle adjustment of the outdoor reflector and the indoor reflector of the view changer according to the present disclosure.

As illustrated in FIGS. 1 to 7, the present disclosure relates to a view changer 100 that not only performs the basic function of a conventional blind, but also protects privacy by blocking a forward view from facing buildings, while allowing an external view from directions without buildings to be seen from the interior space in such a manner that it is divided into segmented views that are vertically parallel without left-right reversal.

The view changer 100 according to the present disclosure is largely composed of three parts: a frame 10, a plurality of indoor reflectors 20 and a plurality of outdoor reflectors 30 that are coupled to the frame 10.

The frame 10 is detachably fitted into a window of a building, and may be easily installed so as to be optionally reversible in a left-and-right direction, as illustrated in (a) and (b) of FIG. 2.

Here, the frame 10 may vary in size depending on the area of the window of the building.

The indoor reflectors 20 are vertically aligned in parallel between a top frame 11 and a bottom frame 12 of the frame 10, thereby functioning to allow the external view to be seen in the form of vertically parallel-segmented views.

Each of the indoor reflectors 20 is installed at an inclination of 45° relative to the interior direction of the building.

At this time, as illustrated in FIG. 4, the interval between the indoor reflectors 20 may be set so that a width-wise indoor-side edge of each of the indoor reflectors is aligned on a vertical line with an outdoor-side edge of an adjacent indoor reflector 20, thereby blocking the forward view.

Here, when the angle of inclination of each of the indoor reflectors 20 is equal to or less than 45°, the incident angle of light from a lateral external view becomes too small, rendering the external view insufficiently visible, which is undesirable. On the other hand, when it exceeds 45°, the forward view is not effectively blocked, which is also undesirable.

As illustrated in (a) of FIG. 5, the outdoor reflectors 30 are arranged at rear sides of the respective indoor reflectors 20, and function to primarily reflect incident light from the external view to adjacent indoor reflectors 20.

Accordingly, as illustrated in FIG. 6, the indoor reflectors 20 function to secondarily reflect the light from the external view already reflected by the outdoor reflectors 30, thereby allowing the light from the external view to enter the interior space so that the external view is seen in the form of vertically parallel-segmented views without left-right reversal.

Additionally, as illustrated in (b) of FIG. 5, the outdoor reflectors 30 are configured so that the reflection angle for reflecting the light from the external view is adjustable relative to the angle of the indoor reflectors 20. To this end, each of the outdoor reflectors 30 includes a first rotation axis 31 that is integrally coupled thereto.

Here, the first rotation axis 31 integrally coupled to each of the outdoor reflectors 30 is disposed at a height substantially half that of the outdoor reflector, and is rotatably coupled to the top frame so as to allow adjustment of the angle of the outdoor reflector.

At this time, a first driven pulley 311 may be externally mounted on an upper end of the first rotation shaft 31 so as to receive rotational force.

As illustrated in FIGS. 1 and 2, a first adjustment lever 112 is coupled to the top frame 11 of the frame 10 so as to be exposed to the interior space. The first adjustment lever includes a first drive pulley 111 and a worm gear WG meshed with the first adjustment lever. The first drive pulley is connected to a belt BT and simultaneously rotates first driven pulleys 311 externally mounted on the respective first rotation axes 31.

Accordingly, a user is able to precisely adjust the angle of the outdoor reflectors 30 by manipulating the first adjustment lever 112 from within the interior space.

The outdoor reflectors 30 are adjustable within a range of 44° to 0° via the first rotation axes 31, thereby functioning to reflect the light from the lateral external view to the indoor reflectors 20.

Here, when the angle of the outdoor reflectors 30 is 0°, it serves as a conventional blind that blocks normal sunlight.

Additionally, the angle of the outdoor reflectors 30 may be adjustable within a range of 44° to 20° when reflecting the light from the external view.

When the reflection angle of the outdoor reflectors 30 is equal to or less than 20°, the incident angle of the light from the external view incident and reflected onto the indoor reflectors 20 becomes too small, thereby rendering the external view insufficiently visible, which is undesirable.

Meanwhile, the indoor reflectors 20 are always installed at 45°, and are adjustable so that the reflection angle becomes 45° relative to the viewpoint of an indoor observer.

To this end, as illustrated in (b) of FIG. 5, each of the indoor reflectors 20 includes a second rotation axis 21 coaxially coupled to the first rotation axis 31. The second rotation axis 21 is coupled to the bottom frame 12 at a height substantially half that of the indoor reflector 20.

At this time, the second rotation axis 21 is coaxially connected to the first rotation axis 31 via a bearing B so as not to cause rotational interference with the first rotation axis 31.

A second adjustment lever 122 is coupled to the bottom frame 12 of the frame 10 so as to be exposed to the interior space. The second adjustment lever includes a second drive pulley 121 and a worm gear WG meshed with the second adjustment lever. The second drive pulley is connected to a belt BT and simultaneously rotates second driven pulleys 211 externally mounted on the respective second rotation axes 21.

Meanwhile, a pleated sheet 40 may be coupled between each of the indoor reflectors 20 and each of the outdoor reflectors 30.

The pleated sheet 40 fills a gap between the indoor reflector 20 and the outdoor reflector 30 to provide a finished appearance, and is configured to contract or expand in response to changes in the angle of the outdoor reflector 30.

Hereinafter, a method of using the view changer according to the present disclosure will be briefly described.

The frame 10 of the view changer 100 according to the present disclosure is fitted into a window of a building.

At this time, the user may install the frame to be optionally reversible in the left-and-right direction depending on the location of a facing building so as to enjoy an external view either from a right direction or from a left direction.

In this state, since the indoor reflectors 20 are set at 45° relative to the interior direction of the building, the user may adjust the reflection angle of the outdoor reflectors 30 to a desired angle by rotating the first adjustment lever 112 as illustrated in (a) of FIG. 7.

First, when the first adjustment lever 112 is rotated, a worm W formed on the first adjustment lever 112 is rotated, causing the worm gear WG meshed with the worm W to be rotated.

At this time, as the first drive pulley 111 coaxially rotatably coupled to the worm gear WG is rotated, the first driven pulleys 311 externally mounted on the first rotation axes 31 of the outdoor reflectors 30 are rotated in conjunction with the rotation of the first drive pulley via the belt BT, thereby allowing the reflection angle of the outdoor reflectors 30 to be adjusted.

Additionally, the user may adjust the reflection angle of the indoor reflectors 20 to 45° relative the viewpoint of an indoor observer sitting on indoor furniture such as a sofa.

As illustrated in (b) of FIG. 7, this is achievable by the second adjustment lever 122 that controls the second driven pulleys 211 externally mounted on the second rotation axes 21 of the indoor reflectors 20.

Meanwhile, the view changer 100 according to the present disclosure may be used as a conventional blind by setting the reflection angle of the outdoor reflectors 30 or both the indoor reflectors 20 and the outdoor reflectors 30 to 0° parallel to the longitudinal axis of the frame 10.

While the present disclosure has been particularly shown and described with reference to exemplary embodiments thereof, it will be understood by those of ordinary skill in the art that various changes and modifications in form and details may be made without departing from the spirit and scope of the present disclosure, as defined by the following claims and their equivalents.

1. A view changer, comprising:
a frame (10) detachably fitted into a window so as to be optionally reversible in a left-and-right direction;
a plurality of indoor reflectors (20) vertically aligned in parallel between a top frame (11) and a bottom frame (12) of the frame (10); and
a plurality of outdoor reflectors (30) arranged at rear sides of the respective indoor reflectors (20) and configured to primarily reflect incident light from an external view to adjacent indoor reflectors (20),
wherein the outdoor reflectors (30) are configured so that a reflection angle for reflecting the light from the external view is adjustable relative to an angle of the indoor reflectors (20), and
the indoor reflectors (20) blocks a forward view and secondarily reflects the light from the external view already reflected by the outdoor reflectors (30), thereby allowing the light from the external view to enter an interior space so that the external view is seen in the form of vertically parallel-segmented views without left-right reversal.

2. The view changer of claim 1, wherein each of the indoor reflectors (20) is installed at an inclination of 45° relative to an interior direction of a building, and
an interval between the indoor reflectors (20) is set so that a width-wise indoor-side edge of each of the indoor reflectors is aligned on a vertical line with an outdoor-side edge of an adjacent indoor reflector (20), thereby blocking the forward view.

3. The view changer of claim 1, wherein each of the outdoor reflectors (30) further includes a first rotation axis (31) coupled to the top frame (11) so as to adjust the reflection angle, and
each of the indoor reflectors (20) includes a second rotation axis (21) coaxially connected to a lower end of the first rotation axis (31) via a bearing (B) and coupled to the bottom frame (12).

4. The view changer of claim 1, wherein a pleated sheet (40) is coupled between each of the indoor reflectors (20) and each of the outdoor reflectors (30).

5. The view changer of claim 3, wherein a first driven pulley (311) is externally mounted on an upper end of the first rotation shaft (31), and
a first adjustment lever (112) is coupled to the top frame (11) of the frame (10) so as to be exposed to the interior space, the first adjustment lever including a worm gear (WG) provided with a first drive pulley (111) configured to rotate the first driven pulley (311) via a belt (BT).

6. The view changer of claim 3, wherein a second driven pulley (211) is externally mounted on a lower end of the second rotation shaft (21), and
a second adjustment lever (122) is coupled to the bottom frame (12) of the frame (10) so as to be exposed to the interior space, the second adjustment lever including a worm gear (WG) provided with a second drive pulley (121) configured to rotate the second driven pulley (211) via a belt (BT).
